(19) United States
(12) Patent Application Publication
(10) Pub. No.: US 2026/0204986 A1
(43) Pub. Date: Jul. 16, 2026

(54) VEHICLE DRIVE DEVICE

(71) Applicant: SUBARU CORPORATION, Tokyo (JP)

(72) Inventors: Naohiro IMAMURA, Tokyo (JP); Tomoko Yoshida, Tokyo (JP); Masayuki Sakai, Tokyo (JP); Toranosuke Sugiyama, Tokyo (JP)

(73) Assignee: SUBARU CORPORATION, Tokyo (JP)

(21) Appl. No.: 19/432,728

(22) Filed: Dec. 24, 2025

(30) Foreign Application Priority Data
Jan. 10, 2025 (JP) 2025-004015

(51) Int. Cl. H02K 9/197; H02K 5/20; H02K 7/00

(52) U.S. Cl. CPC H02K 9/197; H02K 5/203; H02K 7/006

(57) ABSTRACT

A vehicle drive device includes a power unit. The power unit includes an electric motor, a housing that accommodates the electric motor, an oil return channel, a first oil jacket, a second oil jacket, and a shut-off valve. The oil return channel is configured to return oil from a heat exchanger to the housing. The first oil jacket covers an end face of a stator of the electric motor. The second oil jacket covers an outer peripheral face of the stator of the electric motor. The shut-off valve is configured to operate between an open state in which the coupling channel is open, and a closed state in which the coupling channel is closed. The coupling channel couples the oil return channel and the second oil jacket.

### CROSS-REFERENCE TO RELATED APPLICATIONS

The present application claims priority from Japanese Patent Application No. 2025-004015 filed on January 10, 2025, the entire contents of which are hereby incorporated by reference.

### BACKGROUND

The present disclosure relates to a vehicle drive device.

Vehicles such as automobiles and so forth have a power unit incorporating an electric motor (see Japanese Patent No. 5075879, Japanese Patent No. 5075878, and Japanese Patent No. 7190887). Also, the electric motor in the power unit has an oil-cooled structure in which a stator is cooled by oil.

### SUMMARY

A vehicle drive device according to one aspect of the present disclosure includes a heat exchanger and a power unit. The heat exchanger includes a first heat exchange channel that is configured to guide oil, and a second heat exchange channel that is configured to guide a thermal transfer medium. The power unit includes a housing coupled to the first heat exchange channel, an electric motor accommodated in the housing, an oil supply channel, an oil return channel, a first oil jacket, a second oil jacket, and a shut-off valve. The oil supply channel is coupled to an input port of the first heat exchange channel, and is configured to supply oil from the housing to the heat exchanger. The oil return channel is coupled to an output port of the first heat exchange channel, and is configured to return the oil from the heat exchanger to the housing. The first oil jacket is coupled to the oil return channel, and covers an end face of a stator of the electric motor. The second oil jacket is coupled to the oil return channel, and covers an outer peripheral face of the stator of the electric motor. The shut-off valve is provided on a coupling channel that couples the oil return channel and the second oil jacket to each other, and is configured to operate between an open state in which the coupling channel is open and a closed state in which the coupling channel is closed. The shut-off valve is configured to operate to the open state in response to internal pressure of the oil return channel exceeding a threshold value, and to operate to the closed state in response to the internal pressure of the oil return channel falling below the threshold value.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a vehicle equipped with a vehicle drive device according to an embodiment of the present disclosure;

FIG. 2 is a diagram illustrating an execution state of a battery cooling mode;

FIG. 3 is a diagram illustrating an execution state of a battery heating mode;

FIG. 4 is a diagram illustrating an example of a basic structure of an electronic control unit;

FIG. 5 is a diagram illustrating an example of an electric axle and a heat exchanger included in the vehicle drive device;

FIG. 6A is a cross-sectional view illustrating the electric axle taken along line VIA-VIA in FIG. 5;

FIG. 6B is a cross-sectional view illustrating the electric axle taken along line VIB-VIB in FIG. 5;

FIG. 7 is a diagram illustrating oil flow in the electric axle in a low discharge mode;

FIG. 8A is a cross-sectional view illustrating the electric axle taken along line VIIIA-VIIIA in FIG. 7;

FIG. 8B is a cross-sectional view illustrating the electric axle taken along line VIIIB-VIIIB in FIG. 7;

FIG. 9 is a diagram illustrating oil flow in the electric axle in a high discharge mode;

FIG. 10 is a cross-sectional view illustrating the electric axle taken along line X-X in FIG. 9;

FIG. 11 is a flowchart illustrating an example of execution procedures for battery heating control;

FIG. 12 is a diagram illustrating a modification of a vehicle drive device; and

FIG. 13 is a flowchart illustrating an example of execution procedures for heater core heating control.

### DETAILED DESCRIPTION

Warming equipment such as a battery pack and so forth via a heat exchanger by supplying oil in a power unit to the heat exchanger is conceivable. For example, in a very low temperature environment, actively warming the battery pack by providing thermal energy from the power unit to the battery pack via the heat exchanger to improve charging/discharging performance is conceivable. Also, when the heat exchanger is used to warm equipment such as a battery pack and so forth, warming the oil in the power unit at an early stage is conceivable.

Embodiments of the present disclosure will be described in detail below with reference to the drawings. Note that in the following description, configurations and elements that are the same or substantially the same are denoted by the same reference signs and will not be described again. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale.

### Vehicle

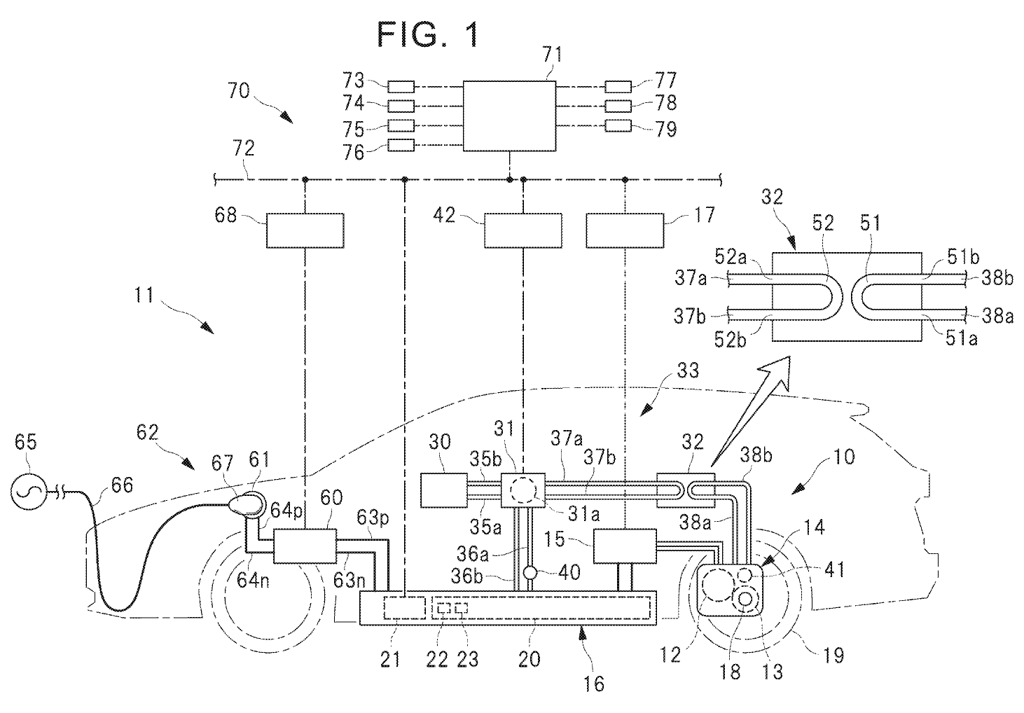

FIG. 1 is a diagram illustrating a vehicle 11 equipped with a vehicle drive device 10 according to an embodiment of the present disclosure. As illustrated in FIG. 1, the vehicle 11 has an electric axle (power unit) 14 that is made up of an electric motor 12 and a differential 13, and a battery pack 16 that is coupled to the electric axle 14 via an inverter 15. A motor control unit 17 that is an electronic control unit executes switching control of the inverter 15, and controls torque and rotation speed of the electric motor 12. Note that the differential 13 of the electric axle 14 is linked to wheels 19 via an axle 18.

The battery pack 16 includes a battery module 20 made up of a plurality of battery cells, and a battery control unit 21 that monitors charging/discharging of the battery module 20. The battery pack 16 also has a battery sensor 22 that detects charge/discharge current, terminal voltage, and so forth, and a temperature sensor 23 that detects temperature of the battery pack 16, i.e., temperature of the battery module 20. The battery control unit 21 that is an electronic control unit determines the temperature of the battery module 20 and calculates a State of Charge (SOC) of the battery module 20.

### Temperature Management System

The vehicle 11 has a temperature management system 33 made up of a radiator 30, a switching valve 31, a heat exchanger 32, and the like. The radiator 30 and the switching valve 31 are coupled to each other via coupling pipes 35a, 35b, and the battery pack 16 and the switching valve 31 are coupled to each other via coupling pipes 36a, 36b. Also, the heat exchanger 32 and the switching valve 31 are coupled to each other via coupling pipes 37a, 37b, and the heat exchanger 32 and the electric axle 14 are coupled to each other via coupling pipes 38a, 38b.

A valve element 31a of the switching valve 31 is operable between a cooling position in which the coupling pipes 35a, 35b, 36a, 36b communicate with each other, and a heating position in which the coupling pipes 36a, 36b, 37a, 37b communicate with each other. The battery pack 16 can be coupled to the radiator 30 by operating the valve element 31a of the switching valve 31 to the cooling position. Also, the battery pack 16 can be coupled to the heat exchanger 32 by operating the valve element 31a of the switching valve 31 to the heating position.

The temperature management system 33 has a water pump 40 that is provided in the coupling pipe 36a and an oil pump 41 that is provided in the electric axle 14. Note that the water pump 40 is an electric water pump driven by an electric motor that is omitted from illustration, and the oil pump 41 is an electric oil pump driven by an electric motor that is omitted from illustration. The temperature management system 33 also includes a temperature control unit 42 that is an electronic control unit. The temperature control unit 42 outputs control signals to the switching valve 31, the water pump 40, the oil pump 41, and so forth, and activates the temperature management system 33 to control the temperature of the battery pack 16 to within a predetermined temperature range.

As illustrated in an enlarged portion of FIG. 1, the heat exchanger 32 has a heat exchange channel (first heat exchange channel) 51 that the coupling pipes 38a, 38b are coupled to, and a heat exchange channel (second heat exchange channel) 52 that the coupling pipes 37a, 37b are coupled to. That is to say, to an input port 51a of the heat exchange channel 51 is coupled the coupling pipe 38a, and to an output port 51b of the heat exchange channel 51 is coupled the coupling pipe 38b. Also, to an input port 52a of the heat exchange channel 52 is coupled the coupling pipe 37a, and to an output port 52b of the heat exchange channel 52 is coupled the coupling pipe 37b. Note that the coupling pipes 35a, 35b, 36a, 36b, 37a, 37b, and the heat exchange channel 52, are filled with a coolant for cooling the battery pack 16. Also, the coupling pipes 38a, 38b and the heat exchange channel 51 are filled with oil supplied from the electric axle 14.

### Battery Cooling Mode, Battery Heating Mode

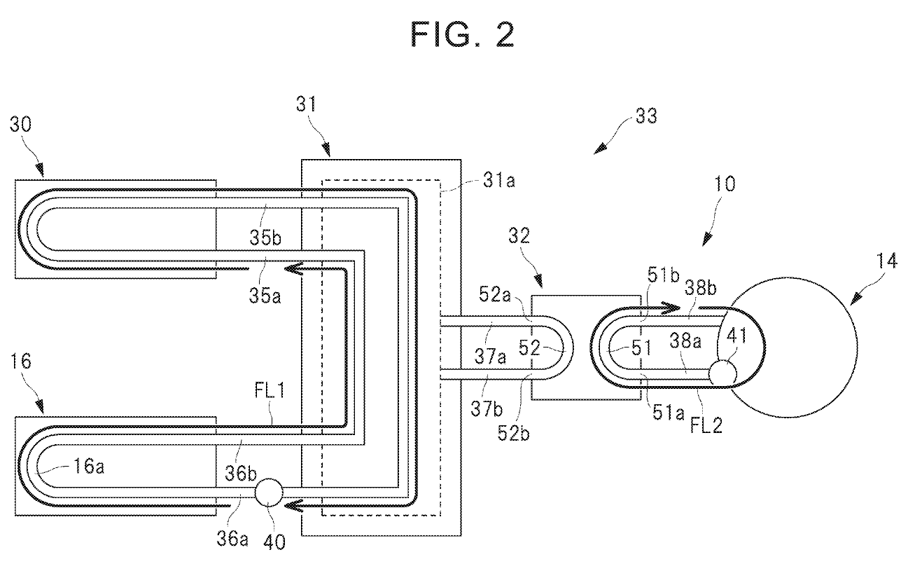

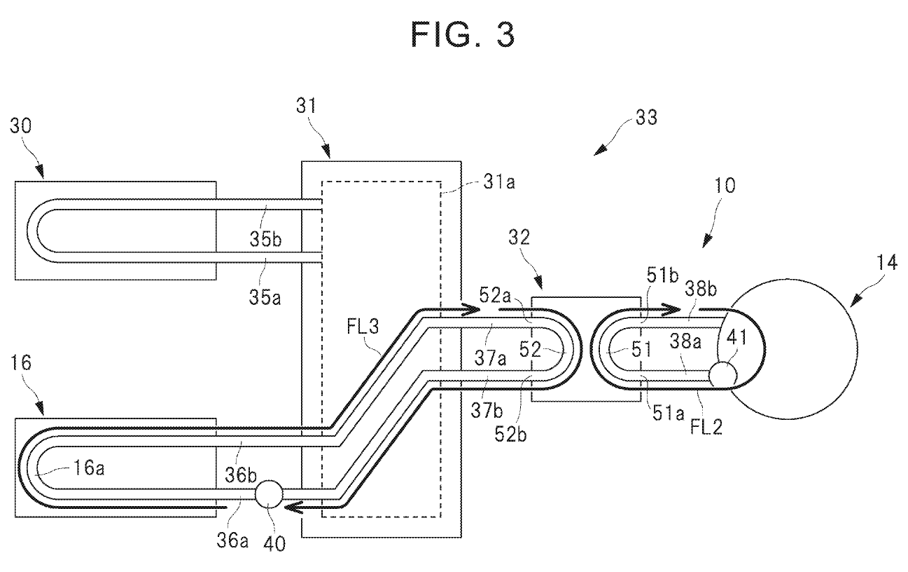

A battery cooling mode and a battery heating mode that are control modes of the temperature management system 33 will be described. Now, FIG. 2 is a diagram illustrating an execution state of the battery cooling mode, and FIG. 3 is a diagram illustrating an execution state of the battery heating mode. The battery cooling mode for cooling the battery pack 16 is a control mode in which the valve element 31a of the switching valve 31 is operated to the cooling position, and is executed when the temperature of the battery pack 16 exceeds a predetermined high-temperature side threshold value, for example. Also, the battery heating mode for warming the battery pack 16 is a control mode for operating the valve element 31a of the switching valve 31 to the heating position, and is executed when the temperature of the battery pack 16 falls below a predetermined low-temperature side threshold value, for example.

As illustrated in FIG. 2, when the battery cooling mode is executed, the temperature control unit 42 operates the valve element 31a of the switching valve 31 to the cooling position and drives the water pump 40. That is to say, by operating the valve element 31a of the switching valve 31 to the cooling position, a cooling channel (thermal transfer medium channel) 16a provided in the battery pack 16 is coupled to the radiator 30 via the coupling pipes 35a, 35b, 36a, 36b. Also, due to the water pump 40 being driven, the coolant (thermal transfer medium) can be circulated between the battery pack 16 and the radiator 30, as illustrated by arrow FL1. This enables the battery pack 16 to be controlled to within an appropriate temperature range.

Note that the cooling channel 16a of the battery pack 16 is configured to guide the coolant among battery cells in the battery module 20, in order to cool the battery cells, which are omitted from illustration. Also, the oil in the electric axle 14 is used for cooling and lubrication, and accordingly the oil pump 41 is driven in accordance with the operating state of the electric axle 14. That is to say, even in the battery cooling mode in which the heat exchanger 32 is disconnected from the battery pack 16, oil circulates between the electric axle 14 and the heat exchanger 32, as illustrated by arrow FL2 in FIG. 2.

As illustrated in FIG. 3, when the battery heating mode is executed, the temperature control unit 42 operates the valve element 31a of the switching valve 31 to the heating position, and drives the water pump 40 and the oil pump 41. Thus, the coolant circulates between the battery pack 16 and the heat exchanger 32, as illustrated by arrow FL3, and oil circulates between the electric axle 14 and the heat exchanger 32, as illustrated by arrow FL2.

That is to say, the coolant flowing through the battery pack 16 is guided to the heat exchanger 32, and the oil warmed in the electric axle 14 is also guided to the heat exchanger 32. This enables thermal energy to be supplied from the electric axle 14 to the battery pack 16 via the heat exchanger 32, thereby actively warming the battery pack 16. In this way, in the battery heating mode, the coolant flowing through the cooling channel 16a of the battery pack 16 serves as a thermal transfer medium for warming the battery pack 16.

### External Charging System

As illustrated in FIG. 1, the vehicle 11 has an external charging system 62 made up of an in-vehicle charger 60, a charging inlet 61, and so forth. The in-vehicle charger 60 is coupled to the battery pack 16 via power cables 63p, 63n. Also, the charging inlet 61 is coupled to the in-vehicle charger 60 via power cables 64p, 64n. Thus, the charging inlet 61 is coupled to the battery pack 16 via the in-vehicle charger 60 that is power conversion equipment. Also, the charging inlet 61 of the vehicle 11 is configured such that a charging connector 67 of a charging cable 66 coupled to an external power supply 65 can be attached and detached.

The external charging system 62 has a charging control unit 68 that is an electronic control unit. A user of the external charging system 62 couples the charging connector 67 to the charging inlet 61. Upon the user performing a predetermined operation to start external charging, the charging control unit 68 then outputs a control signal to the in-vehicle charger 60. Thus, the in-vehicle charger 60 converts alternating current power from the external power supply 65 into direct current power, and the in-vehicle charger 60 supplies the direct current power to the battery pack 16. In this way, the charging control unit 68 outputs a control signal to the in-vehicle charger 60 and controls the operating state of the external charging system 62.

### Control System

As illustrated in FIG. 1, the vehicle 11 has a control system 70 made up of a plurality of electronic control units. The electronic control units that make up the control system 70 include the motor control unit 17, the battery control unit 21, the temperature control unit 42, and the charging control unit 68 described above. The electronic control units making up the control system 70 also include a vehicle control unit 71 that outputs control signals to the control units 17, 21, 42, 68 described above.

These control units 17, 21, 42, 68, 71 are coupled to each other via an in-vehicle network 72 so as to be capable of mutually communicating. The vehicle control unit 71 sets operation targets for the temperature management system 33 and the external charging system 62, based on input information from the various control units 17, 21, 42, 68, and various types of sensors described below. The vehicle control unit 71 also generates control signals in accordance with the operation targets for the temperature management system 33 and so forth, and outputs these control signals to the various types of control units 17, 21, 42, 68.

Sensors that are coupled to the vehicle control unit 71 include a vehicle speed sensor 73 that detects vehicle speed, which is traveling speed of the vehicle 11, an accelerator sensor 74 that detects an accelerator operation amount, which is the amount of accelerator pedal operation, and a brake sensor 75 that detects a brake pedal operation amount. Sensors coupled to the vehicle control unit 71 include a rotational speed sensor 76 that detects rotational speed of the oil pump 41, a temperature sensor 77 that detects temperature of the oil circulating through the electric axle 14, and a temperature sensor 78 that detects temperature of the coolant circulating through the battery pack 16. Further, a start switch 79 that is operated by a driver who will drive the vehicle 11 when starting up the control system 70, is coupled to the vehicle control unit 71.

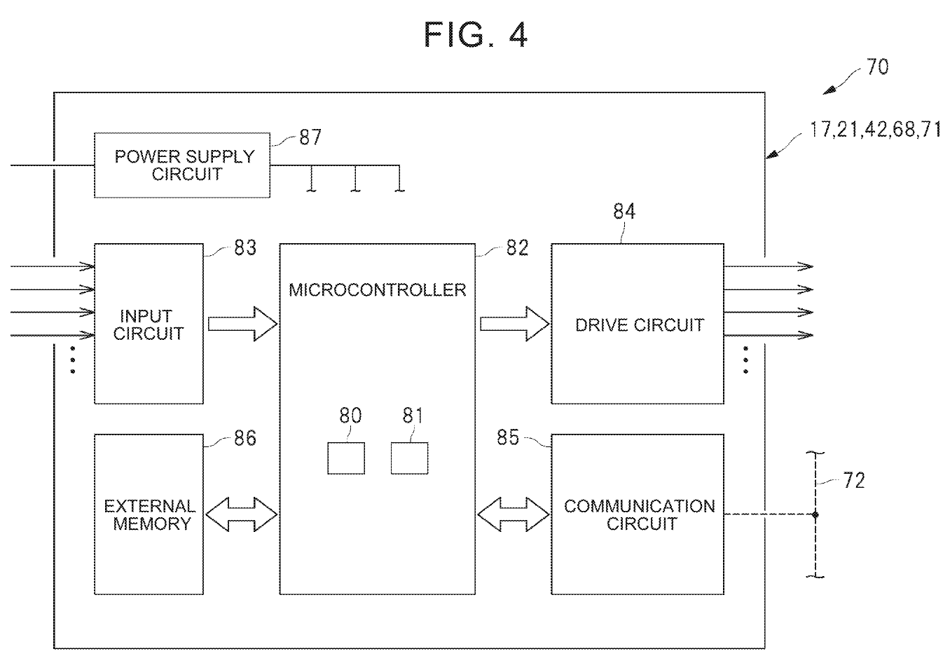

FIG. 4 is a diagram illustrating an example of a basic structure of the electronic control units 17, 21, 42, 68, 71. As illustrated in FIG. 4, the electronic control units 17, 21, 42, 68, 71 each have a microcontroller 82 in which a processor 80, a main memory (memory) device 81, and so forth, are built in. The main memory device 81 stores a predetermined program, and this program is executed by the processor 80. The processor 80 and the main memory device 81 are coupled to each other so as to be capable of mutually communicating. It should be noted that a plurality of the processors 80 may be built into the microcontroller 82, and a plurality of the main memory devices 81 may be built into the microcontroller 82.

The electronic control units 17, 21, 42, 68, 71 each include an input circuit 83, a drive circuit 84, a communication circuit 85, external memory 86, and a power supply circuit 87. The input circuit 83 converts signals received from various types of sensors into signals that can be input to the microcontroller 82. The drive circuit 84 generates drive signals for devices such as the inverter 15, the in-vehicle charger 60, and so forth, based on signals output from the microcontroller 82. The communication circuit 85 converts the signals output from the microcontroller 82 into communication signals directed to another electronic control unit or the like. Also, the communication circuit 85 converts the communication signals received from other electronic control units and so forth into signals that can be input to the microcontroller 82. Further, the power supply circuit 87 supplies a power supply voltage to the microcontroller 82, the input circuit 83, the drive circuit 84, the communication circuit 85, the external memory 86, and so forth. Also, the external memory 86 that is made up of nonvolatile memory or the like stores programs, various types of data, and so forth.

### Electric Axle

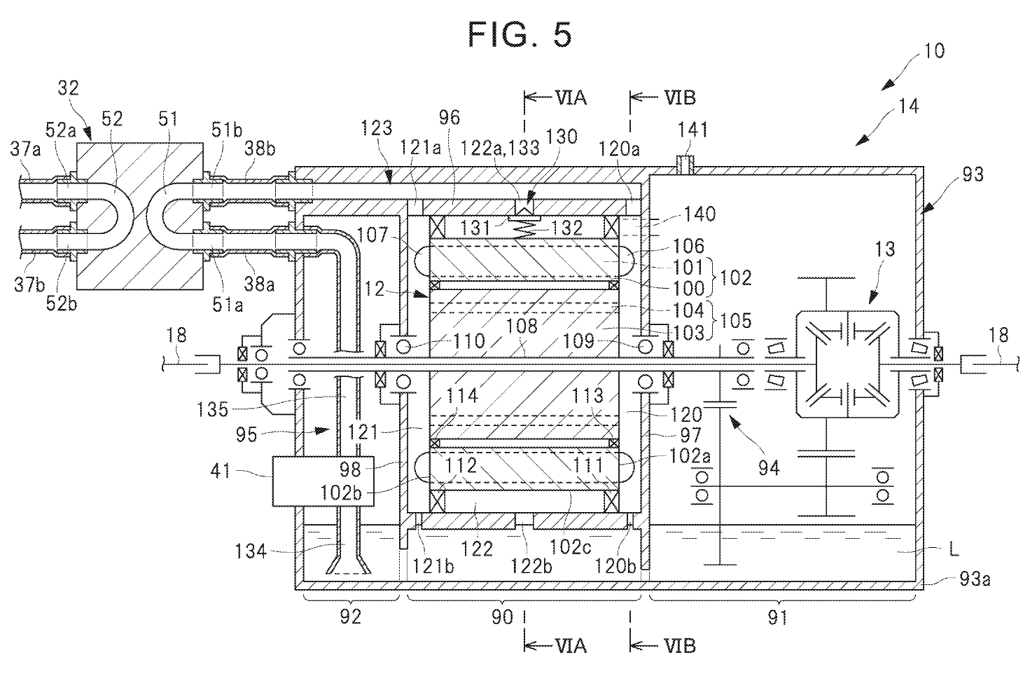

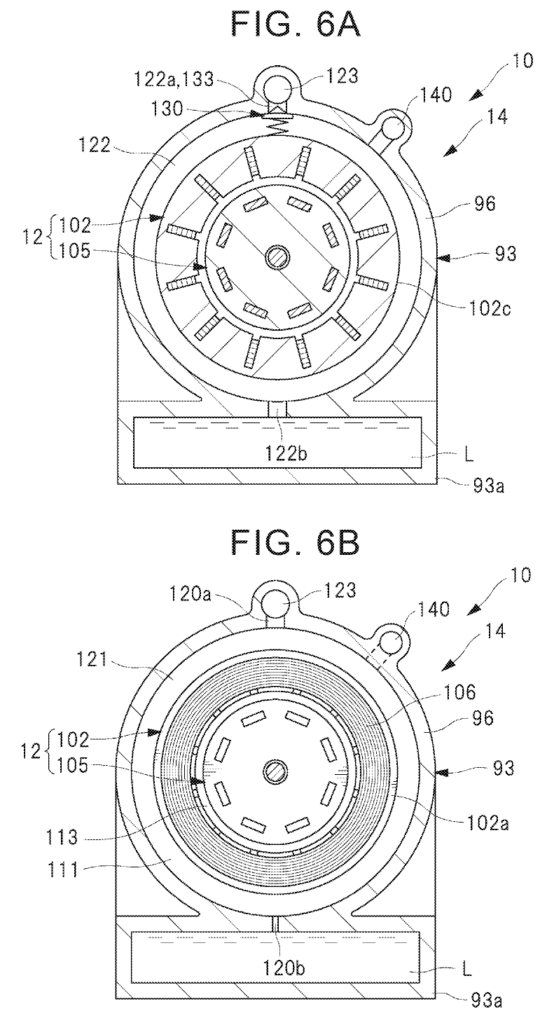

A structure of the electric axle 14 will be described in detail below. FIG. 5 is a diagram illustrating an example of the electric axle 14 and the heat exchanger 32 included in the vehicle drive device 10. FIG. 6A is a cross-sectional view illustrating the electric axle 14 taken along line VIA-VIA in FIG. 5, and FIG. 6B is a cross-sectional view illustrating the electric axle 14 taken along line VIB-VIB in FIG. 5.

As illustrated in FIG. 5, the electric axle 14 has a housing 93 that includes a motor accommodation chamber 90, a gear accommodation chamber 91, and a pump accommodation chamber 92. Oil L that is used for lubrication and cooling is pooled in the housing 93. Also, the motor accommodation chamber 90 accommodates the electric motor 12, the gear accommodation chamber 91 accommodates a reduction gear train 94 and the differential 13, and the pump accommodation chamber 92 accommodates an oil supply channel 95 that is equipped with the oil pump 41. The motor accommodation chamber 90 of the housing 93 is defined by a sleeve wall 96 that surrounds the electric motor 12, a partition wall 97 coupled to one end of the sleeve wall 96, and a partition wall 98 coupled to the other end of the sleeve wall 96. Note that motor accommodation chamber 90 and the gear accommodation chamber 91 are partitioned by the partition wall 97, and the motor accommodation chamber 90 and the pump accommodation chamber 92 are partitioned by the partition wall 98.

The electric motor 12 accommodated in the housing 93 has a stator 102 that is made up of a stator core 100 and a stator coil 101, and a rotor 105 that is made up of a rotor core 103 and a permanent magnet 104. The stator 102 includes a coil end 106 of the stator coil 101 that protrudes from one end face of the stator core 100, and a coil end 107 of the stator coil 101 that protrudes from the other end face of the stator core 100. Also, a rotor shaft 108 that is fixed to the rotor core 103 is rotatably supported by the partition walls 97, 98 via bearings 109, 110. Further, the stator core 100 is fixed to the sleeve wall 96 via bolts that are omitted from illustration.

Two seal rings 111, 112 are attached between an inner peripheral face of the sleeve wall 96 and an outer peripheral face of the stator 102. Two seal rings 113, 114 are attached between the inner peripheral face of the stator 102 and an outer peripheral face of the rotor 105. In this way, incorporating the seal rings 111 to 114 into the motor accommodation chamber 90 defines a plurality of oil jackets 120, 121, 122 in the motor accommodation chamber 90. That is to say, a side jacket (first oil jacket) 120 that covers one end face (stator end face) 102a of the stator 102, and a side jacket (first oil jacket) 121 that covers the other end face (stator end face) 102b of the stator 102, are defined in the motor accommodation chamber 90. Also, a sleeve jacket (second oil jacket) 122 that covers an outer peripheral face (stator outer peripheral face) 102c of the stator 102 is defined in the motor accommodation chamber 90.

As illustrated in FIGS. 5, 6A and 6B, an upper portion of the sleeve wall 96 has an oil return channel 123. The oil return channel 123 is coupled to the output port 51b of the heat exchange channel 51 via the coupling pipe 38b. Also, the upper portion of the sleeve wall 96 has an inlet port 120a communicating with the side jacket 120, an inlet port 121a communicating with the side jacket 121, and an inlet port 122a communicating with the sleeve jacket 122. Further, a lower portion of the sleeve wall 96 has a drainage port 120b communicating with the side jacket 120, a drainage port 121b communicating with the side jacket 121, and a drainage port 122b communicating with the sleeve jacket 122. The drainage ports 120b, 121b, 122b provided in the lower part of the sleeve wall 96 open toward an oil pan 93a provided in a lower part of the housing 93. That is to say, the drainage ports 120b, 121b, 122b open to inside of the housing 93.

As illustrated in FIGS. 5 and 6A, the electric axle 14 has a shut-off valve 130 that opens and closes the inlet port 122a of the sleeve jacket 122. The shut-off valve 130 that is disposed inside the sleeve jacket 122 includes a valve element 131 facing the inlet port 122a, and a spring 132 that biases the valve element 131 toward the inlet port 122a. When internal pressure of the oil return channel 123 exceeds a predetermined threshold value, the valve element 131 moves away from the inlet port 122a under oil pressure, and accordingly the shut-off valve 130 operates to an open state that opens the inlet port 122a. On the other hand, when internal pressure of the oil return channel 123 falls below the predetermined threshold value, spring force of the spring 132 causes the valve element 131 to come into contact with the inlet port 122a, and accordingly the shut-off valve 130 operates to a closed state that blocks the inlet port 122a. In other words, the electric axle 14 has the shut-off valve 130 provided in a coupling channel 133 that couples the oil return channel 123 and the sleeve jacket 122 to each other. The shut-off valve 130 operates in an open state in which the coupling channel 133 is opened, and in a closed state in which the coupling channel 133 is closed.

As illustrated in FIGS. 5 and 6B, the drainage port 120b of the side jacket 120 is smaller than the inlet port 120a of the side jacket 120. That is to say, the cross-sectional area of the channel of the drainage port 120b is smaller than the cross-sectional area of the channel of the inlet port 120a. Similarly, the drainage port 121b of the side jacket 121 is smaller than the inlet port 121a of the side jacket 121. That is to say, the cross-sectional area of the channel of the drainage port 121b is smaller than the cross-sectional area of the channel of the inlet port 121a.

As illustrated in FIG. 5, the electric axle 14 has the oil supply channel 95 that supplies oil from the oil pan 93a of the housing 93 to the heat exchanger 32, and the oil return channel 123 that returns oil from the heat exchanger 32 to the housing 93. That is to say, the input port 51a of the heat exchanger 32 is coupled to the oil supply channel 95 via the coupling pipe 38a, and the output port 51b of the heat exchanger 32 is coupled to the oil return channel 123 via the coupling pipe 38b. Also, the oil supply channel 95 is made up of a strainer 134, the oil pump 41, and a supply pipe 135.

As illustrated in FIGS. 5 and 6A, the electric axle 14 has a communication channel 140 by which the sleeve jacket 122 and the gear accommodation chamber 91 communicate with each other. The electric axle 14 also has a breather port 141 for communication between inside and outside of the gear accommodation chamber 91. That is to say, the sleeve jacket 122 and the breather port 141 communicate with each other via the communication channel 140 and the gear accommodation chamber 91. That is to say, the sleeve jacket 122 communicates with the outside of the housing 93 via the communication channel 140, the gear accommodation chamber 91 and the breather port 141.

### Low Discharge Mode, High Discharge Mode

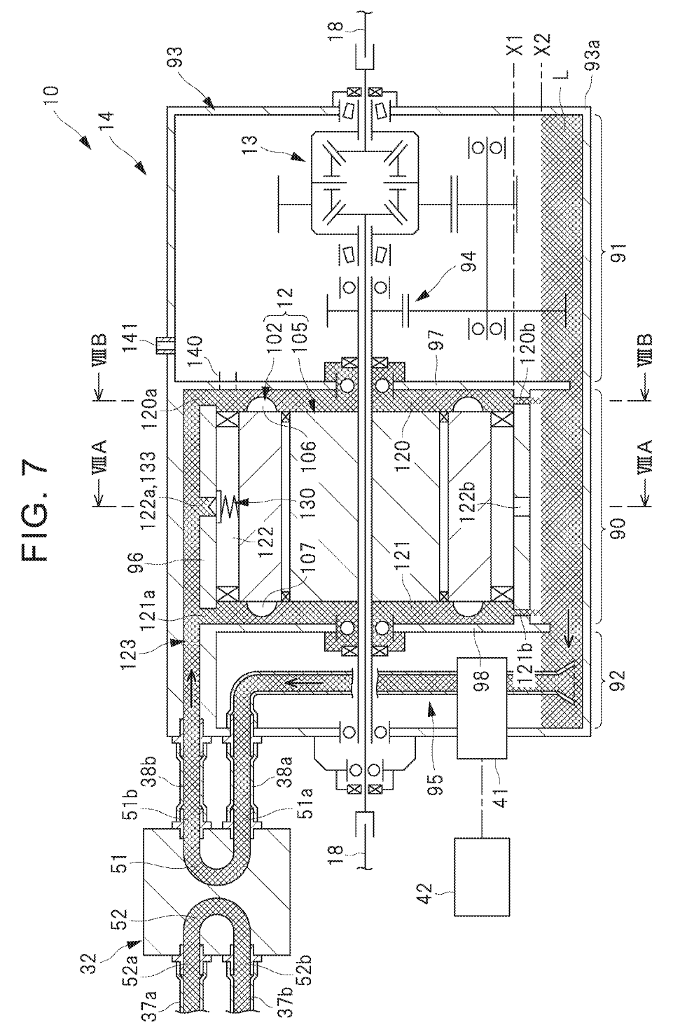

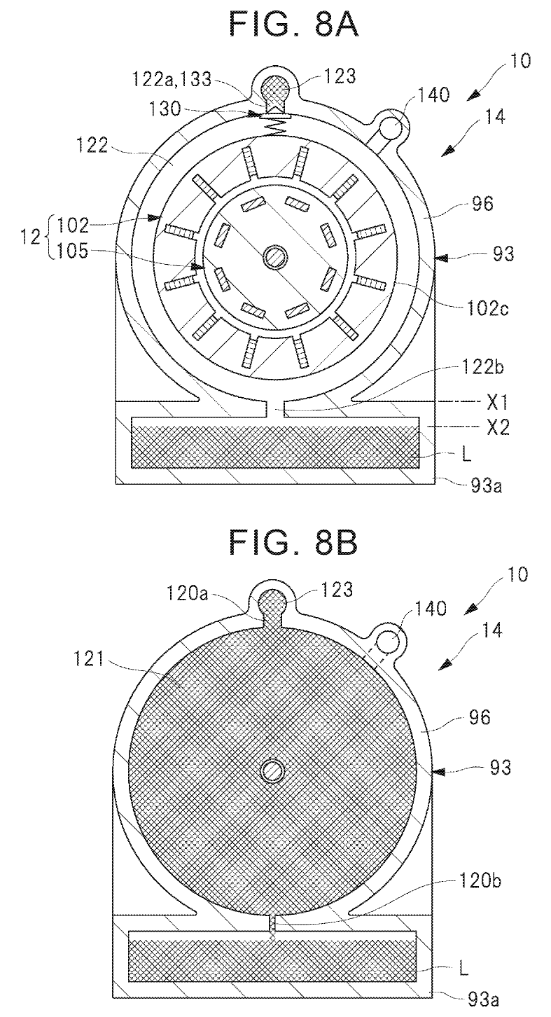

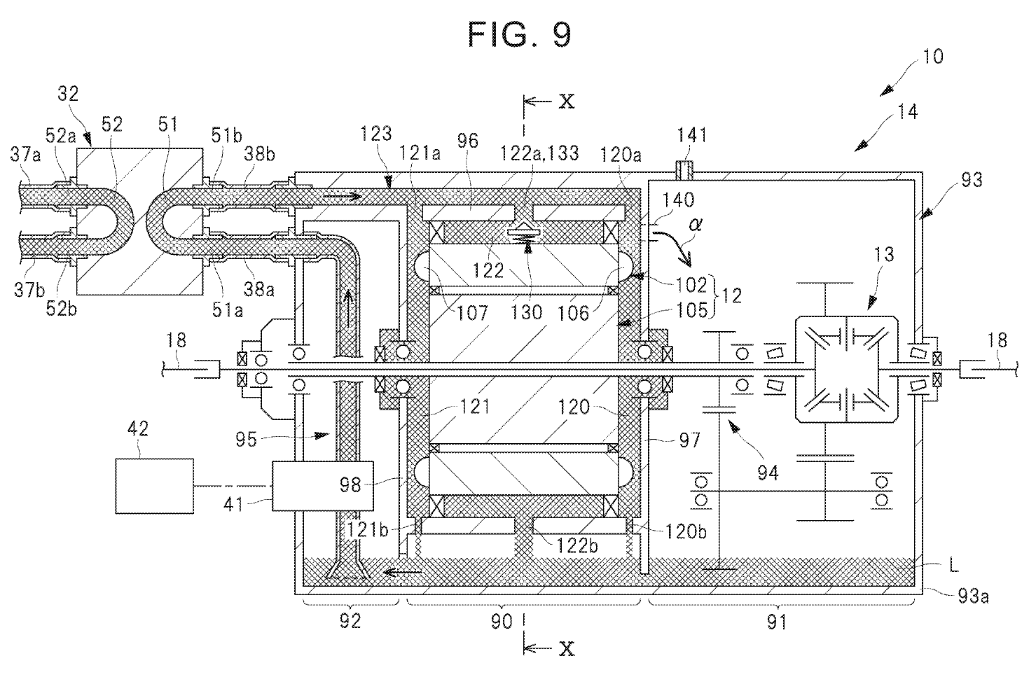

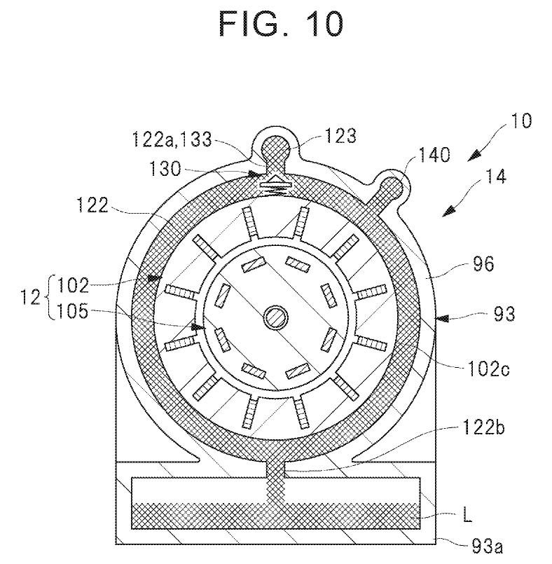

A low discharge mode and a high discharge mode that are control modes of the oil pump 41 will be described. Now, FIG. 7 is a diagram illustrating oil flow in the electric axle 14 in the low discharge mode. FIG. 8A is a cross-sectional view illustrating the electric axle 14 taken along line VIIIA-VIIIA in FIG. 7, and FIG. 8B is a cross-sectional view illustrating the electric axle 14 taken along line VIIIB-VIIIB in FIG. 7. Also, FIG. 9 is a diagram illustrating oil flow in the electric axle 14 in the high discharge mode. FIG. 10 is a cross-sectional view illustrating the electric axle 14 taken along line X-X in FIG. 9. Note that in FIGS. 7, 8A, 8B, 9 and 10, the oil and the coolant are indicated by cross-hatching. Also, in FIGS. 7 and 9, the arrows in the cross-hatching indicate direction of oil flow.

As illustrated in FIG. 7, when the low discharge mode is executed, the temperature control unit 42 controls the rotation speed of the oil pump 41 within a range below a predetermined threshold value. Thus, suppressing the rotation speed of the oil pump 41, i.e., amount of oil discharged enables a flow rate of oil supplied from the oil pump 41 to the oil return channel 123 via the heat exchanger 32 to be reduced. Accordingly, the internal pressure of the oil return channel 123 can be made to transition below the predetermined threshold value. Thus, the inlet port 122a of the sleeve jacket 122 is closed by the shut-off valve 130, as illustrated in FIGS. 7 and 8A. Accordingly, oil is not supplied from the oil return channel 123 to the sleeve jacket 122, and oil is supplied from the oil return channel 123 to just the side jackets 120, 121.

As illustrated in FIGS. 7 and 8B, the channel cross-sectional area of the drainage port 120b in the side jacket 120 is smaller than the channel cross-sectional area of the inlet port 120a. In other words, the inlet port 120a of the side jacket 120 is larger than the drainage port 120b of the side jacket 120. That is to say, in the side jacket 120, the amount of oil supplied is greater than the amount of oil drained. This enables oil to be pooled in substantially the entire side jacket 120 even when the oil pump 41 is driven in the low discharge mode. Similarly, the cross-sectional area of the channel of the drainage port 121b in the side jacket 121 is smaller than the cross-sectional area of the channel of the inlet port 121a. In other words, the inlet port 121a of the side jacket 121 is larger than the drainage port 121b of the side jacket 121. That is to say, in the side jacket 121, the amount of oil supplied is greater than the amount of oil drained. This enables oil to be pooled in substantially the entire side jacket 121 even when the oil pump 41 is driven in the low discharge mode.

In this way, in the low discharge mode, oil is supplied just to the side jackets 120, 121 from the oil return channel 123, and accordingly the oil is quickly warmed by the coil ends 106, 107. When oil is supplied to the sleeve jacket 122 in a very low temperature environment, for example, a great amount of thermal energy is transferred from the oil to the sleeve wall 96, thereby making it difficult to quickly raise the oil temperature. In contrast, in the low discharge mode, the oil supply to the sleeve jacket 122 is cut off, and accordingly the oil can be warmed quickly.

Note that as illustrated in FIGS. 7 and 8A, in the low discharge mode, a lower end position X1 of the sleeve jacket 122 is situated upward from oil level X2. Thus, when the low discharge mode is executed, no oil flows into the sleeve jacket 122, and the oil can be quickly warmed even in a very low temperature environment. Also, outside air is introduced into the sleeve jacket 122 through the breather port 141, and accordingly oil is drained from the sleeve jacket 122 in the low discharge mode.

As illustrated in FIG. 9, when the high discharge mode is executed, the temperature control unit 42 controls the rotation speed of the oil pump 41 within a range above the predetermined threshold value. In this way, increasing the rotational speed of the oil pump 41 and increasing the oil discharge amount enables the oil flow rate supplied from the oil pump 41 to the oil return channel 123 via the heat exchanger 32 to be increased, and the internal pressure of the oil return channel 123 can be made to transition above the predetermined threshold value. Thus, as illustrated in FIGS. 9 and 10, the inlet port 122a of the sleeve jacket 122 is opened by the shut-off valve 130, and accordingly oil can be supplied from the oil return channel 123 to the sleeve jacket 122.

In this way, in the high discharge mode, oil is supplied from the oil return channel 123 to the sleeve jacket 122 and the side jackets 120, 121. That is to say, in the high discharge mode, a great amount of thermal energy is transferred from the oil passing through the sleeve jacket 122 to the sleeve wall 96, and accordingly the stator 102 can be actively cooled by the oil. Note that in the high discharge mode, as illustrated by arrow α in FIG. 9, oil flows from the sleeve jacket 122 to the gear accommodation chamber 91 via the communication channel 140, and the oil is supplied to the differential 13 and the reduction gear train 94.

### Battery Heating Control

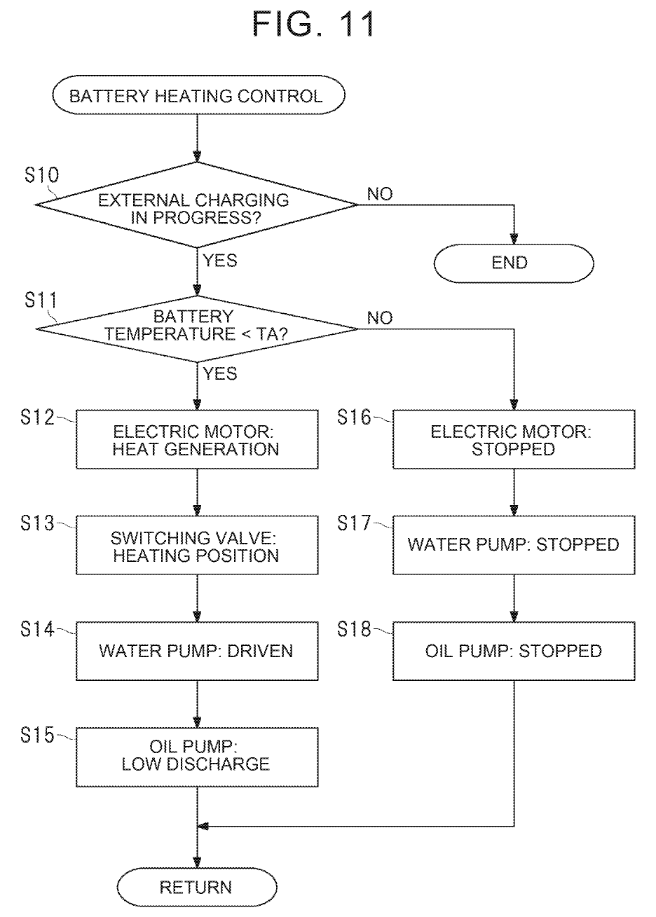

Next, battery heating control executed during external charging in a very low temperature environment will be described. FIG. 11 is a flowchart illustrating an example of execution procedures for battery heating control. Note that each step illustrated in the flowchart of FIG. 11 is a step that is executed by the processor 80 that makes up the control system 70.

As illustrated in FIG. 11, the control system 70 advances to step S10 and determines whether external charging is being performed in which the charging connector 67 is coupled to the charging inlet 61, i.e., whether external charging is being performed in which the external power supply 65 is coupled to the battery pack 16. Upon determining in step S10 that external charging is being performed, the control system 70 advances to step S11, and determines whether the temperature of the battery pack 16 (hereinafter referred to as "battery temperature") is below a predetermined threshold value TA.

Upon determining in step S11 that the battery temperature is lower than the threshold value TA, the control system 70 advances to step S12, and controls the electric motor 12 in a heat generation mode. Here, the heat generation mode of the electric motor 12 is a control mode in which current is passed through just one phase of the stator coil 101. Executing this heat generation mode enables the stator coil 101 of the electric motor 12 to be made to actively generate heat without rotating the rotor 105 of the electric motor 12.

The control system 70 advances to step S13, operates the valve element 31a of the switching valve 31 to the heating position, advances to step S14, and drives the water pump 40. The control system 70 also advances to step S15, and drives the oil pump 41 in the low discharge mode. Accordingly, as illustrated in FIG. 7, the supply of oil from the oil return channel 123 to the sleeve jacket 122 can be cut off, and the oil can be actively warmed by the coil ends 106, 107. The thermal energy of the warmed oil is then transferred from the heat exchanger 32 to the battery pack 16 via the coolant. Thus, warming the battery pack 16 by the oil of the electric axle 14 enables internal resistance of the battery pack 16 to be reduced. Accordingly, the battery pack 16 can be efficiently charged even in a very low temperature environment. That is to say, according to one aspect of the present disclosure, by operating the shut-off valve 130 to the closed state, the oil in the electric axle 14 (power unit) can be warmed at an early stage.

On the other hand, upon determining in step S11 that the battery temperature is at the threshold value TA or higher, the control system 70 advances to steps S16, S17, S18, and the electric motor 12, the water pump 40, and the oil pump 41 are stopped. That is to say, when the battery temperature is at an expected temperature during external charging, external charging of the battery pack 16 is carried out using the external power supply 65, while operating none of the electric motor 12, the water pump 40, and the oil pump 41.

In the above description, the oil pump 41 is controlled in the low discharge mode during external charging, but this is not restrictive. For example, the oil pump 41 may be controlled in the low discharge mode when the vehicle is traveling in a very low temperature environment. That is to say, when the battery temperature falls below the threshold value TA, the control system 70 may operate the valve element 31a of the switching valve 31 to the heating position, drive the water pump 40, and drive the oil pump 41 in the low discharge mode. This enables the battery pack 16 to be actively warmed by the oil of the electric axle 14. Accordingly, the internal resistance of the battery pack 16 can be reduced in a very low temperature environment, and output characteristics during charging and discharging can be improved.

### Modification 1

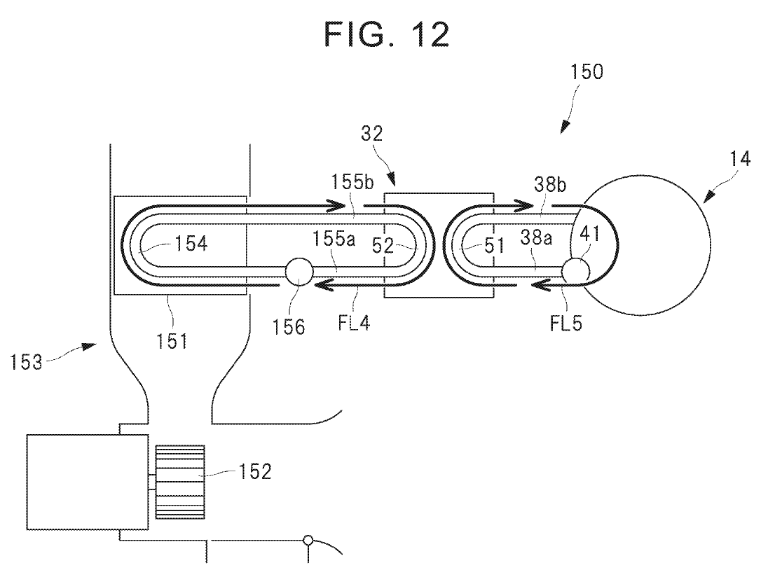

In the example illustrated in FIGS. 2 and 3, the battery pack 16 is coupled to the heat exchanger 32 via the switching valve 31, but this is not restrictive. For example, equipment other than the battery pack 16 may be coupled to the heat exchanger 32. FIG. 12 is a diagram illustrating a modification of a vehicle drive device 150. In FIG. 12, the same components and elements as those illustrated in FIG. 2 are denoted by the same reference signs, and description thereof will be omitted.

As illustrated in FIG. 12, the vehicle drive device 150 has air conditioning equipment 153 made up of a heater core 151, a blower 152, and so forth. The heat exchange channel 52 of the heat exchanger 32 and a heat exchange channel 154 of the heater core 151 are coupled to each other via coupling pipes 155a, 155b. Also, the coupling pipe 155a is provided with a circulation pump 156 for pumping circulating fluid (thermal transfer medium). Driving the circulation pump 156 and the oil pump 41 circulates the circulation fluid between the heater core 151 and the heat exchanger 32 as illustrated by arrow FL4, and circulates the oil between the electric axle 14 and the heat exchanger 32 as illustrated by arrow FL5. This enables thermal energy to be supplied from the electric axle 14 to the heater core 151 via the heat exchanger 32, and the heater core 151 can be actively warmed by the oil of the electric axle 14.

### Heater Core Heating Control

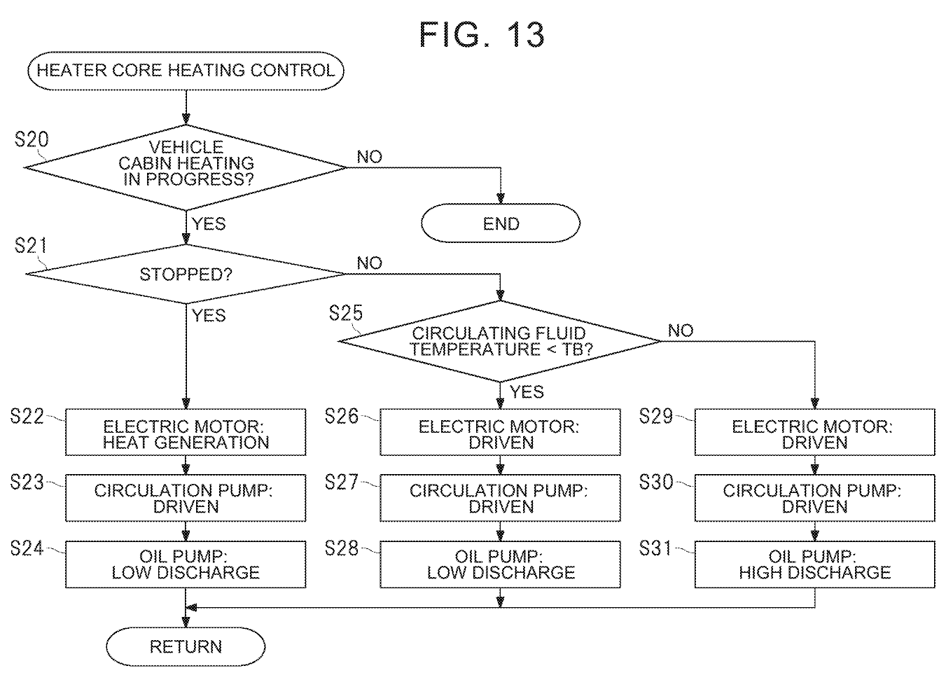

Heater core heating control that is executed during vehicle cabin heating will be described. FIG. 13 is a flowchart illustrating an example of execution procedures for heater core heating control. Note that each step illustrated in the flowchart of FIG. 13 is a step that is executed by the processor 80 that makes up the control system 70.

As illustrated in FIG. 13, the control system 70 advances to step S20 and determines whether the heater core 151 is operating to heat the vehicle cabin. Upon determining in step S20 that the vehicle cabin is being heated, the control system 70 advances to step S21, and determines whether the vehicle 11 is stopped. Upon determining in step S21 that the vehicle is stopped, the control system 70 advances to step S22, and controls the electric motor 12 in the heat generation mode. The control system 70 advances to step S23 and drives the circulation pump 156, and advances to step S24 and drives the oil pump 41 in the low discharge mode.

On the other hand, when determining in step S21 that the vehicle is traveling, the control system 70 advances to step S25 and determines whether the temperature of the circulating fluid flowing through the heater core 151 (hereinafter referred to as "circulating fluid temperature") is below a predetermined threshold value TB. Upon determining in step S25 that the circulating fluid temperature is lower than the threshold value TB, the control system 70 advances to step S26, and drives the electric motor 12 in accordance with the accelerator operation amount or the like. The control system 70 also advances to step S27 and drives the circulation pump 156, and advances to step S28 and drives the oil pump 41 in the low discharge mode.

In this way, when the vehicle is stopped or when the temperature of the circulating fluid is low, the oil pump 41 is driven in the low discharge mode. Accordingly, as illustrated in FIG. 7, the supply of oil from the oil return channel 123 to the sleeve jacket 122 can be cut off, and the oil can be actively warmed by the coil ends 106, 107. The thermal energy of the warmed oil is then transferred from the heat exchanger 32 to the heater core 151 via the circulating fluid. In this way, quickly warming the oil in the electric axle 14 enables the heater core 151 to be warmed at an early stage, even in a very low temperature environment.

As illustrated in FIG. 13, upon determining in step S25 that the circulating fluid temperature is at the threshold value TB or higher, the control system 70 advances to step S29, and drives the electric motor 12 in accordance with the accelerator operation amount or the like. The control system 70 also advances to step S30 and drives the circulation pump 156, and advances to step S31 and drives the oil pump 41 in the high discharge mode. In this way, when the temperature of the circulating fluid is high, i.e., when the heater core 151 is sufficiently warm, the oil pump 41 is driven in the high discharge mode. In this case, as illustrated in FIG. 9, the inlet port 122a of the sleeve jacket 122 is opened and the electric motor 12 is actively cooled.

### Other Modifications

The present disclosure is not limited to the above-described embodiments, and various modifications can be made without departing from the spirit thereof. In the illustrated example, the housing 93 is provided with two side jackets 120, 121, but this is not restrictive. For example, the housing 93 may be provided with just one of the side jackets 120, 121. In the above description, the shut-off valve 130 that is opened and closed by pressure applied to the valve element 131 is used, but this is not restrictive. For example, a shut-off valve that is opened and closed by electromagnetic force may be used. In the above description, when the heat generation mode of the electric motor 12 is executed, current is passed through just one phase of the stator coil 101, but this is not restrictive. For example, current may be passed through three phases of the stator coil 101 in a state in which the electric motor 12 is braked.

In the illustrated example, the electric axle 14 that drives the wheels 19 that are rear wheels is used as the power unit, but this is not restrictive. For example, the electric axle may be a power unit that drives front wheels, or may be a power unit that drives both the front wheels and the rear wheels. In the illustrated example, the control system 70 is made up of a plurality of electronic control units 17, 21, 42, 68, 71, but this is not restrictive. For example, the control system 70 may be made up of a single electronic control unit. In the illustrated example, the heat exchanger 32 is coupled to the housing 93 via the coupling pipes 38a, 38b, but this is not restrictive. For example, the heat exchanger 32 and the housing 93 may be directly coupled.

What is claimed is:

1. A vehicle drive device comprising:
a heat exchanger comprising
a first heat exchange channel that is configured to guide oil, and
a second heat exchange channel that is configured to guide a thermal transfer medium; and
a power unit comprising
a housing that is coupled to the first heat exchange channel, and
an electric motor that is accommodated in the housing, wherein
the power unit comprises
an oil supply channel that is coupled to an input port of the first heat exchange channel, and that is configured to supply oil from the housing to the heat exchanger,
an oil return channel that is coupled to an output port of the first heat exchange channel, and that is configured to return the oil from the heat exchanger to the housing,
a first oil jacket that is coupled to the oil return channel, and that covers an end face of a stator of the electric motor,
a second oil jacket that is coupled to the oil return channel, and that covers an outer peripheral face of the stator of the electric motor, and
a shut-off valve that is provided on a coupling channel that couples the oil return channel and the second oil jacket to each other, and that is configured to operate between an open state in which the coupling channel is open and a closed state in which the coupling channel is closed, and
the shut-off valve is configured to operate to the open state in response to internal pressure of the oil return channel exceeding a threshold value, and to operate to the closed state in response to the internal pressure of the oil return channel falling below the threshold value.

2. The vehicle drive device according to claim 1, wherein a thermal transfer medium channel of a battery pack is coupled to the second heat exchange channel.

3. The vehicle drive device according to claim 2, further comprising:
an oil pump that is provided on the oil supply channel; and
a control system comprising a processor and a memory that are communicatively coupled to each other, wherein the control system is configured to control the oil pump to an oil discharge amount that operates the shut-off valve to the closed state in response to an external power supply being coupled to the battery pack and temperature of the battery pack falling below a threshold value.

4. The vehicle drive device according to claim 1, wherein:
the first oil jacket comprises an inlet port that communicates with the oil return channel, and a drainage port that opens to inside of the housing; and
a channel cross-sectional area of the drainage port is smaller than a channel cross-sectional area of the inlet port.

5. The vehicle drive device according to claim 1, wherein the second oil jacket communicates with a breather port.
